(19) United States
(12) Patent Application Publication
(10) Pub. No.: US 2024/0391511 A1
(43) Pub. Date: Nov. 28, 2024

(54) TROLLEY FOR SUPPORTING A LABELING STATION IN A LABELING MACHINE

(71) Applicant: P.E. LABELLERS S.P.A., Porto Mantovano (IT)

(72) Inventor: Luca BONARDI, San Giorgio Bigarello (IT)

(21) Appl. No.: 18/696,119

(22) PCT Filed: Sep. 15, 2022
(86) PCT No.: PCT/EP2022/075688

§ 371 Date: Mar. 27, 2024

(30) Foreign Application Priority Data
Sep. 30, 2021 (IT) 102021000025016

(51) Int. Cl. B62B 3/02

(52) U.S. Cl. CPC B62B 3/02; B62B 2205/104; B62B 2206/06

(57) ABSTRACT

A trolley for supporting a labeling station in a labeling machine, which includes a trolley body which is provided with wheels and defines in an upper region a work surface for supporting a labeling station, and at least one supporting bracket for at least one of the wheels; the supporting bracket has at least one coupling portion for mounting at least one respective wheel; the supporting bracket is, furthermore, fixable to the trolley body in at least two different arrangements, in order to vary the position in terms of height of the coupling portion with respect to the trolley body.

The present invention relates to a trolley for supporting a labeling station in a labeling machine.

Carousel labeling machines of the modular type are known, in which the labeling stations are supported by a trolley which is provided with wheels which are detachably coupled to the frame of the carousel, so as to be able to easily equip the machine with different labeling stations, such as, for example, stations provided with pre-glued labels or stations provided with devices for gluing with hot or cold glue, with a consequent saving of costs.

Typically, trolleys for supporting labeling stations have a work surface on which the component elements of the corresponding labeling station are mounted.

In particular, the trolleys are pre-assembled so that their work surface is aligned with and at the same height as the plane of the carousel, once the trolleys are coupled to the frame of that carousel.

However, it often happens that, owing to irregularities or slopes in the floor of the building, it is found during installation of the machine that the work surfaces of the trolleys as pre-assembled are not at the correct height from the floor to be aligned with the plane of the carousel.

In order to be capable of adjusting the height from the floor of the work surface of the trolley, the wheels of the trolley are currently provided with a respective vertical adjustment pin in which a plurality of holes are defined, situated at different heights and selectively engageable using screws, for directly fixing the wheels to the body of the trolley.

With this solution, however, unless the adjustment pins are extremely long, it is not possible, in every use case, to easily compensate for the difference in height that may arise between the work surface of the trolley and the plane of the carousel, once the trolley is coupled to the carousel.

The aim of the present invention is to provide a trolley for supporting a labeling station in a labeling machine, which is capable of improving the known art in one or more of the above mentioned aspects.

Within this aim, an object of the invention is to provide a trolley for supporting a labeling station in a labeling machine that makes it possible to ensure the positioning of the work surface of the trolley at the correct height from the floor with respect to the plane of the carousel.

Another object of the invention is to provide a trolley for supporting a labeling station in a labeling machine that is easy and practical in use for the operators.

Another object of the invention is to provide a trolley for supporting a labeling station in a labeling machine that is structurally very simple to provide.

Another object of the invention is to provide a trolley for supporting a labeling station in a labeling machine that is reliable and safe during its use.

A further object of the present invention is to overcome the drawbacks of the background art in a manner that is alternative to any existing solutions.

Another object of the invention is to provide a trolley for supporting a labeling station in a labeling machine that can be competitive from a purely economic viewpoint as well.

This aim and these and other objects which will become better apparent hereinafter are achieved by a trolley for supporting a labeling station in a labeling machine according to claim 1, optionally provided with one or more of the characteristics of the dependent claims.

Further characteristics and advantages of the invention will become better apparent from the detailed description that follows of a preferred, but not exclusive, embodiment of the trolley for supporting a labeling station in a labeling machine according to the invention, which is illustrated by way of non-limiting example in the accompanying drawings, wherein:

FIG. 1 is a perspective view of the supporting trolley of a labeling station according to the invention, with a supporting bracket for the wheels in a first arrangement;

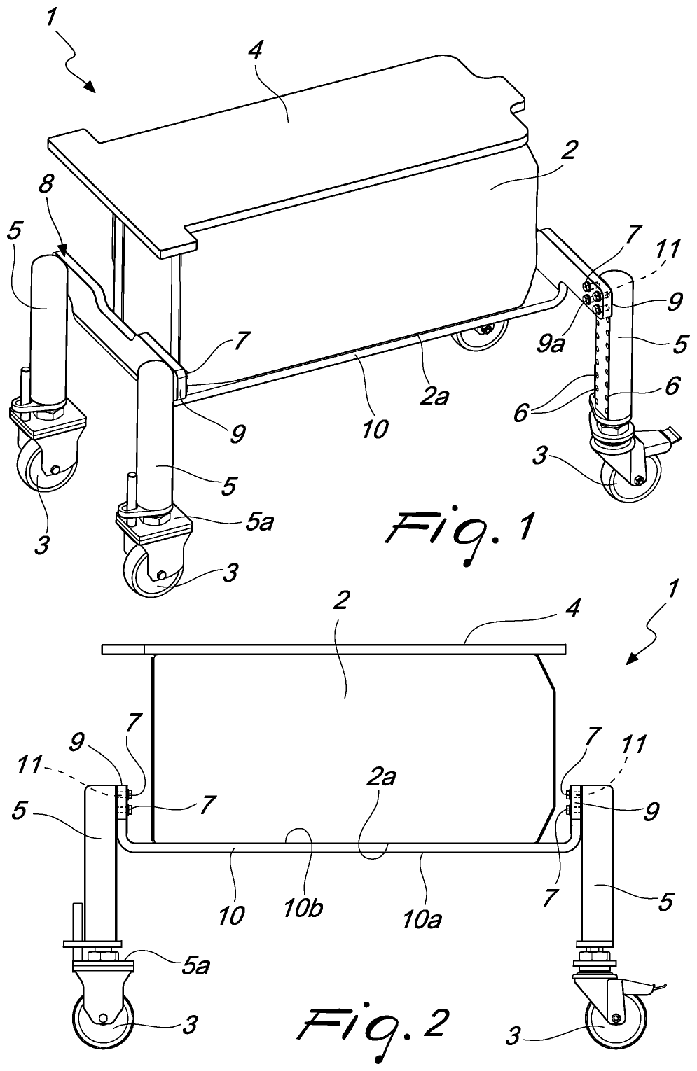

FIG. 2 is a side view of the trolley according to the invention with the supporting bracket in the first arrangement;

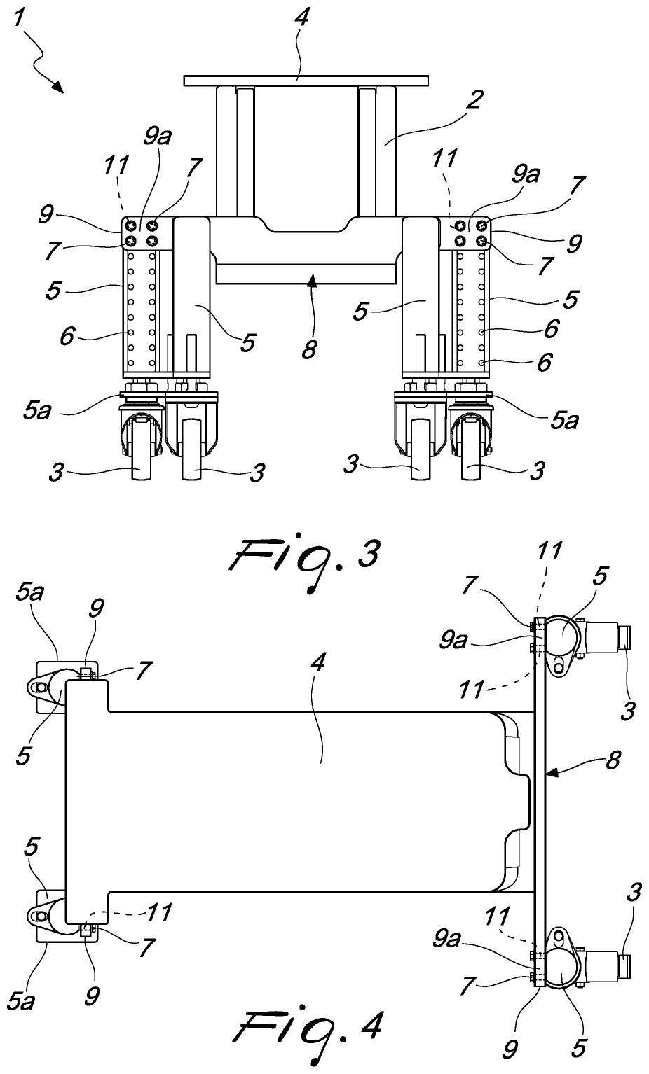

FIG. 3 is a front elevation view of the trolley according to the invention with the supporting bracket in the first arrangement;

FIG. 4 is a plan view from above of the trolley according to the invention with the supporting bracket in the first arrangement;

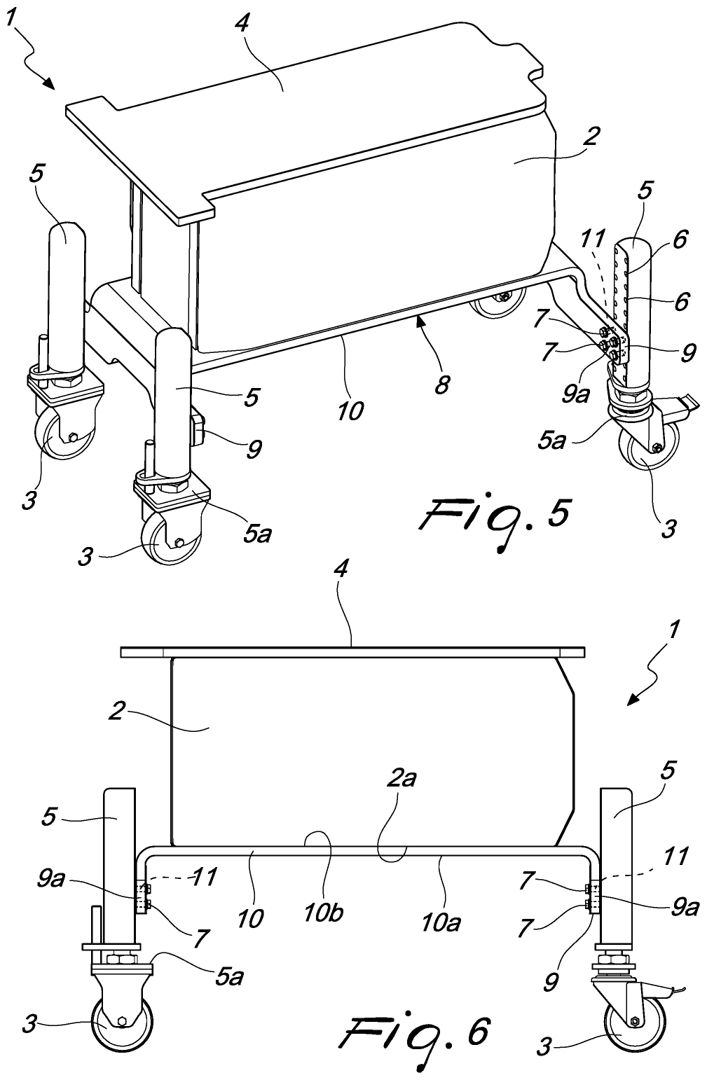

FIG. 5 is a perspective view of the trolley according to the invention but with the supporting bracket in a second arrangement;

FIG. 6 is a side view of the trolley according to the invention with the supporting bracket in the second arrangement;

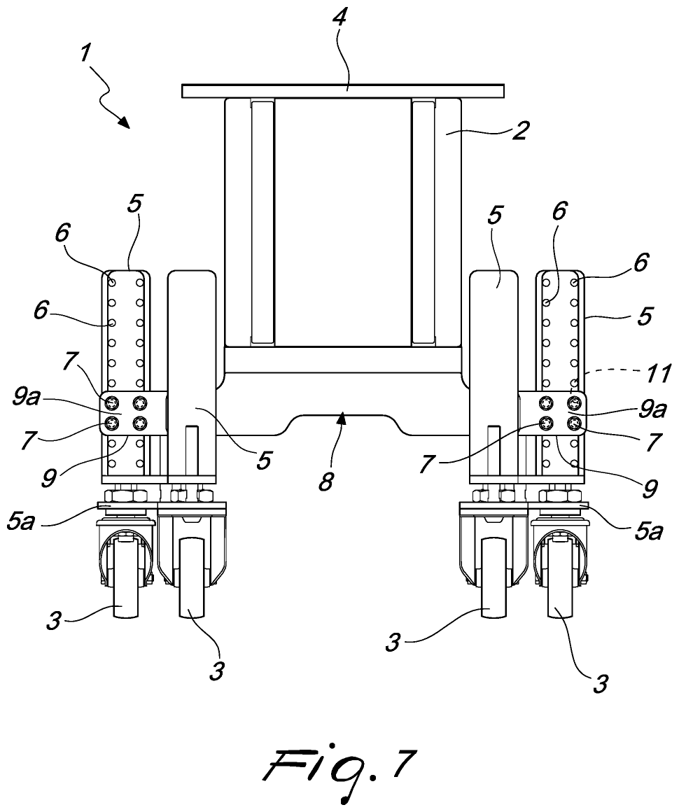

FIG. 7 is a front elevation view of the trolley according to the invention with the supporting bracket in the second arrangement.

With reference to the figures, the trolley for supporting a labeling station in a labeling machine according to the invention, generally designated by the reference numeral 1, comprises a trolley body 2 which is provided, in a lower region, with wheels 3 and which defines, in an upper region, a work surface 4, on which a labeling station, not shown, is mounted.

The trolley body 2 can advantageously be provided, at its front, with means, which are conventional and not shown for the sake of simplicity, that allow it to be fixed to the peripheral region of a carousel of the machine, also not shown.

Conveniently, each one of the wheels 3 is provided with a respective adjustment pin 5, in order to enable their connection to the trolley body 2 in different positions along a substantially vertical direction.

In particular, the adjustment pin 5 of each wheel 3 extends substantially vertically from a corresponding base 5a on which the corresponding wheel 3 is rotatably mounted.

More specifically, along the adjustment pin 5, conveniently at a longitudinal flattened area, a plurality of fixing holes 6 are defined, advantageously regularly spaced apart from each other parallel to the axis of the adjustment pin 5, which are selectively engageable using a locking screw 7, in order to connect the corresponding wheel 3 to the trolley body 2 in the desired position.

The peculiarity of the invention consists in that it comprises at least one supporting bracket 8, which has at least one coupling portion 9 for mounting at least one respective wheel 3 and, more preferably, multiple coupling portions 9 for mounting at least two wheels 3.

In particular, the supporting bracket 8 is fixable to the trolley body 2 in at least two different arrangements, in order to allow the possibility to vary the position in terms of height, i.e. along a substantially vertical direction, of the coupling portions 9 with respect to the trolley body 2, so as to be able to extend the capacity to adjust the position of the corresponding wheel 3 with respect to the trolley body 2 and consequently have a greater capacity to adjust the position in terms of height of the work surface 4 with respect to the floor, for the same length of the adjustment pins 5 of the wheels 3.

More specifically, the supporting bracket 8 is selectively fixable to the trolley body 2 in at least one first arrangement, like that shown for example in FIG. 1, where the respective coupling portions 9 are arranged at a first vertical distance with respect to the trolley body 2, or in at least one second arrangement, like that shown for example in FIG. 5, in which the coupling portions 9 are arranged at a second vertical distance with respect to the trolley body 2, different and, for example, greater than the first distance.

In more detail, the (or each) supporting bracket 8 advantageously has at least one substantially plate-like portion 10 and at least two respective coupling portions 9, each one of which defines at least one corresponding fixing region 9a for a respective wheel 3.

In particular, the coupling portions 9 are arranged at mutually opposite ends of the substantially plate-like portion 10 and are situated on the same side with respect to the plane of arrangement of the substantially plate-like portion 10.

More specifically, the fixing region 9a of each coupling portion 6 is, in turn, arranged spaced apart from the plane of arrangement of the substantially plate-like portion 7 along a direction that is substantially perpendicular to that same plane of arrangement of the substantially plate-like portion 7.

The substantially plate-like portion 10 is furthermore fixable to a substantially horizontal lower face 2a of the trolley body 2, selectively with one of its own faces 10a or with its opposite face 10b, so as to be able to arrange, according to requirements, the coupling portions 9 respectively downward or upward with respect to the plane of arrangement of the substantially plate-like portion 10.

The fixing of the substantially plate-like portion 10 of the supporting bracket 8 is, conveniently, done using means for detachable connection, such as, for example, screws or the like.

Preferably, as shown in the figures, there can be a single supporting bracket 8 which has, at opposite ends of its own substantially plate-like portion 10, two pairs of coupling portions 9.

In particular, the single supporting bracket 8 has a pair of coupling portions 9 at each end of the substantially plate-like portion 10 arranged along the longitudinal extension of the trolley body 2 i.e. one pair at the end intended to be positioned at the front of the trolley body 2 and one pair intended to be positioned at the rear of the trolley body 2.

Advantageously, the fixing region 9a of each coupling portion 9 is arranged on a plane substantially perpendicular to the plane of arrangement of the substantially plate-like portion 10 and is provided with one or more engagement holes 11 for the connection of the wheels 3 to the coupling portions 9.

In particular, by selectively positioning the fixing holes 6 of the adjustment pin 5 of a wheel 3 so as to be aligned with engagement holes 11, which are defined in the fixing region 9a of the corresponding coupling portion 9, and by inserting respective locking screws 7, which can be screwed into female screw seats defined for example in the fixing holes 6, through engagement holes 11 defined in the fixing region 9a and through the selected fixing holes 6 of the adjustment pin 5 which have been positioned so as to be aligned with the engagement holes 6, it is possible to execute the anchoring of the adjustment pin 5 to the corresponding coupling portion 9 with the corresponding wheel 3 in the position, with respect to the trolley body 2, that makes it possible to obtain the correct positioning of the work surface 4 with respect to the plane of the carousel.

Preferably, for greater stability of the trolley, the coupling portions 9 are, advantageously, arranged, at least with one of their parts, in a position that is laterally spaced apart with respect to the side walls of the trolley body 2.

Preferably, the supporting bracket 8 of the wheels 3 is provided by means of a shaped plate, conveniently made of metal.

In particular, the plate that provides the supporting bracket 8 is shaped so as to present, in side view, i.e. from the side of its edges that are intended to be arranged along the longitudinal extension of the trolley body 2, a shape substantially like a C, as can be seen in FIGS. 2 and 6, while, at its ends located along the longitudinal extension of the trolley body 2, it has, in a front elevation view, a shape substantially like an Ω, as can be seen from FIGS. 3 and 7.

The use of the labeling station supporting trolley, according to the invention, is the following.

With the trolley positioned proximate to the carousel, the operator verifies that the work surface 4 is located at the correct height from the floor.

If an adjustment of the position of the work surface 4 needs to be carried out, and the length of the adjustment pins 5 is not sufficient for the correct positioning in terms of height of the work surface 4, then the operator modifies the arrangement of the supporting bracket 8, so as to vary the position in terms of height of the coupling portions 9 with respect to the trolley body 2 and as a consequence have a more extended adjustment range available.

Thus, for example, if a trolley configuration is required with the work surface 4 at lower heights, the supporting bracket 8 can be fixed to the trolley body 2 in the first arrangement, while if a trolley configuration is required with the work surface at higher heights, the supporting bracket 8, after being detached from the trolley body 2, and rotated 180° about an axis parallel to the plane of arrangement of its substantially plate-like portion 10, is once again fixed to the lower face 2b of the trolley body 2 with the other face of its substantially plate-like portion, so that the coupling portions 9 are positioned below the plane of arrangement of its substantially plate-like portion 10.

In practice it has been found that the invention fully achieves the intended aim and objects and, in particular, attention is drawn to the fact that the trolley according to the invention, by virtue of the presence of the supporting bracket for the wheels and the possibility to vary its arrangement, makes it possible to extend the range of adjustment of the position in terms of height of the work surface on which the labeling station is mounted, without requiring considerably long adjustment pins of the wheels.

The invention thus conceived is susceptible of numerous modifications and variations, all of which are within the scope of the appended claims. Moreover, all the details may be substituted by other, technically equivalent elements.

In practice, the materials used, as well as the contingent shapes and dimensions, may be any according to the requirements and to the state of the art.

The disclosures in Italian Patent Application No. 102021000025016 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-7. (canceled)

8. A trolley for supporting a labeling station in a labeling machine, comprising a trolley body which is provided with wheels and defines in an upper region a work surface for supporting a labeling station, further comprising at least one supporting bracket for at least one of said wheels, said supporting bracket having at least one coupling portion for mounting of at least one respective wheel, said supporting bracket being configured to be fixed to said trolley body in at least two different arrangements, in order to vary a position in terms of height of said at least one coupling portion with respect to said trolley body.

9. The trolley according to claim 8, wherein said at least one supporting bracket comprises said coupling portions for at least two of said wheels, said supporting bracket being configured to be selectively fixed to said trolley body in at least one first arrangement, in which the respective coupling portions are arranged at a first vertical distance with respect to said trolley body, or in at least one second arrangement, in which said coupling portions are arranged at a second vertical distance with respect to said trolley body.

10. The trolley according to claim 8, wherein said at least one supporting bracket has at least one substantially plate-like portion and at least two respective said coupling portions, each one of which defines at least one corresponding fixing region for a respective one of said wheels, said coupling portions being arranged at mutually opposite ends of said substantially plate-like portion and being situated on a same side with respect to a plane of arrangement of said substantially plate-like portion, the fixing region of each coupling portion being arranged spaced apart from the plane of arrangement of said substantially plate-like portion along a direction that is substantially perpendicular to the plane of arrangement of said substantially plate-like portion, said substantially plate-like portion being configured to be fixed to a lower face of said trolley body, selectively with one of faces thereof or with an opposite face, in order to arrange said coupling portions respectively upward or downward with respect to the plane of arrangement of said substantially plate-like portion.

11. The trolley according to claim 10, wherein said at least one supporting bracket is a single supporting bracket which has, at opposite ends of its own substantially plate-like portion, two pairs of said coupling portions.

12. The trolley according to claim 10, wherein the fixing region of each coupling portion is arranged on a plane that is substantially perpendicular to the plane of arrangement of said substantially plate-like portion.

13. The trolley according to claim 8, wherein each one of said wheels has a respective adjustment pin with a substantially vertical extension, along said adjustment pin there being a plurality of fixing holes which are configured to be positioned selectively so as to be aligned with engagement holes, which are defined in the fixing region of the corresponding coupling portion, for an anchoring of said adjustment pin to the corresponding coupling portion by means of at least one locking screw.

14. The trolley according to claim 8, wherein said coupling portions are arranged, at least with one of parts thereof, in a position that is laterally spaced apart with respect to side walls of said trolley body.
